(19) United States
(12) Patent Application Publication
(10) Pub. No.: US 2019/0384616 A1
(43) Pub. Date: Dec. 19, 2019

(54) METHOD FOR DISPLAYING AND CHANGING MOBILE COMMERCE ELEMENTS WITHIN NATIVE APPLICATION INSTANTLY WITHOUT CODE BUILD

(71) Applicant: MUTHUKRISHNAN GOVINDARAJ, PARLIN, NJ (US)

(72) Inventor: MUTHUKRISHNAN GOVINDARAJ, PARLIN, NJ (US)

(21) Appl. No.: 16/011,004

(22) Filed: Jun. 18, 2018

(51) Int. Cl. G06F 9/445; G06Q 30/06; G06F 8/38

(52) U.S. Cl. CPC G06F 9/44505; G06F 8/38; G06Q 30/0643

(57) ABSTRACT

In a general native mobile commerce application the eCommerce elements like shopping cart, quick cart, add to cart, checkout button, discount code box, promotional offer image banner, product image sliders and carousel, product image advertisement banner, product categories icons or list, product specification sheet display, product price offers, customer support call button, tag cloud, best products, top selling products, deal products, label-ribbons-stickers, flash sale count down timer, social share, product statistics are displayed in a customized screen display options and are merchants specific screen options and design of the mobile application using programming code implemented by the developer. This system allows the merchants to bring these mobile commerce elements but not limited to this list, in the mobile commerce application by specifying, storing, validating and generating computer codes and parameters within the internal storage of the native mobile commerce application. The elements are displayed dynamically in the customer's mobile commerce application instantly with a click of the button by the merchant. The merchant doesn't require code build process for their native mobile application code for this element display and changes. This invention is also allowing the merchant to store computer codes for different screen options and mobile commerce screen design. The invention enables the merchant to display the screen elements options targeted for the mobile user audience from different criteria like mobile user location, mobile user gender, mobile user age, based on other personal profile information by matching the profile information to the screen display option assigned for the criteria but not limited to this list. The merchant will use a web-based application to define these screen options from another entity or software module. The screen options programming code defined by the merchant will be published to mobile devices of end customers' mobile commerce application screen, immediately without any code build process as native mobile elements. This method doesn't use web-view, hybrid or HTML5 techniques for displaying the mobile commerce elements dynamically. The new design will be reflected in the ecommerce application of the user mobile device as soon as the merchant make it available. The new design screen options and parameter information are dynamically available from the ecommerce back-end web-server as JSON data format via RESTful web services and are stored within the native ecommerce mobile app as local storage data. The new design option for the screen and parameter information includes the page design code information, display rule information, ecommerce element content information, URI information for images and media assets and page and elements render priority order information and other element property information.

### FIELD OF INVENTION

The invention is in relation with general computer systems and native mobile application systems in the eCommerce domain and is specific for displaying and changing the mobile commerce elements within a native mobile application instantly without code build.

### BACKGROUND OF THE INVENTION

Ecommerce has emerged into new era after the availability of smartphones and mobile applications into the market. People use smartphones and mobile applications most widely in recent days. Also, everyone is using mobile ecommerce applications for buying things online, avail services online with a tap. Since the trend for the shopping through mobile is increasing, merchants also prefer to distribute ecommerce mobile apps to their customers, so they can increase sales via mobile application. The merchants wanted a system using which they can give their mobile commerce application to their customers that look and function as unique application from their competitor's apps. They look for opportunity to create a unique screen options, unique designs, make use of their ingenious ideas into their app screen options, so that it will bring more sales for their products. The customers also look for a guided shopping and personalized shopping experience through their mobile application. The merchants are required to build customer location specific, age specific and other condition specific pages and screen options in the traditional method of native mobile commerce application development. This traditional approach of implementing all these different condition specific pages, elements and screen options for different mobile platform of eCommerce mobile application leads to huge cost, time and human efforts. Also, the outcome of this investment in time, money and effort will give only few limited combination of screen options, element options and would require custom development for every other options.

The proposed system and the method used in this application, enable the merchant to create, specify any ecommerce elements into their native ecommerce mobile application by themselves without any programming language for different screen options, different ecommerce element options, platform independent screen options solution and without code rebuild process. They can use a computer browser based graphical user interface using which they can select the ecommerce element, position the ecommerce element onto a Mobile commerce application screen options in the browser application, then specify the parameters for the mobile commerce element and define rules for its functioning. This method for displaying and changing the mobile commerce elements on a native mobile application screen will give continuous engagement of users within the ecommerce mobile applications for those users who prefer to see new contents, latest offers, new banner images in the native ecommerce mobile applications. Otherwise they may not open or use the native ecommerce mobile application. And the mobile application merchant may lose those users.

The prior art or invention methods doesn't provide a method for how to display or change the mobile ecommerce shopping cart element, mobile ecommerce product price display element, mobile ecommerce advertisement banners display element, mobile ecommerce promotional banners display element, mobile ecommerce product navigation element, mobile ecommerce URI element, mobile ecommerce application content block element, mobile ecommerce product category banners and icons elements, mobile ecommerce product promotional box, mobile ecommerce product discount label or ribbon display element, mobile ecommerce product navigations button elements but not limited to this list.

In addition to that, the prior art or inventions doesn't have methods on how to change the screen options or position of ecommerce elements in an ecommerce application screen on user mobile device instantly. The prior art or methods also don't have methods for rendering ecommerce elements content sent across servers and user mobile devices and from mobile storage content to user's mobile application screen instantly without code build. Using the proposed system, the merchants can display or change the ecommerce elements that are designed to their native ecommerce mobile application in user's screen without any code build process and without any application resubmitting process to the application distribution stores.

The proposed new method or system must have the features to code ecommerce elements in a simple computer code format, transmit the same to a web back end server from where it is distributed to user's mobile devices, stored in user's ecommerce mobile application cache storage. The proposed new method or system must also have the features for checking active version of the screen option to load on ecommerce application, criteria validation engine that reads customer profile and other user's conditions to validate along other set rules for loading ecommerce mobile application elements, select the elements from local cache storage in native application code format and renders in the order and position defined by the merchant. Various other changing and display methods have also been devised in art. The other prior inventions and its deficient methods to solve customer problem have been explained below. Some of them are as follows:

The invention ‘Method and system for customizing a mobile application using a web-based interface’ U.S. Pat. No. 9,836,446 [Dec. 5, 2017], is an invention that claims to provide a system and method for customizing mobile-form applications via a web-based interface for distribution to a mobile device. This invention speaks about a customized mobile-form application from a predefined or customizable mobile-form application template by selecting a form field with labels and values. This art is dealing with the mobile form elements which are different from mobile commerce elements. This invention lacks the features and methods for the mobile commerce elements rendering, changing the positions of the mobile commerce elements on user's mobile screen in a native mobile commerce application based on the profile conditions, environment conditions and other validation rules set for the display. This art also requires the deploying of the said mobile-form application version whereas the proposed art doesn't require deploying for every ecommerce elements positions and its screen options versions to the user's mobile device application.

The invention ‘Systems and methods for dynamically modifying functionality and content of a mobile application based on location criteria’ U.S. Pat. No. 9,830,611 [Nov. 28, 2017], is an invention that claims to a system and methods for dynamically modifying functionality and content of a mobile application based on location criteria. The current end user's location information may be compared with the user-specified by the location requirement and the current time may be compared with the user-selected period requirement. If they satisfy with the current end user's location information and current time with user specified time requirements, then the application functionality and content of the mobile application may be generated. This invention lacks the feature of native mobile commerce application elements rendering method dynamically such as mobile ecommerce shopping cart element, mobile ecommerce product price display element, mobile ecommerce advertisement banners display element, mobile ecommerce promotional banners display element, mobile ecommerce product navigation element, mobile ecommerce URI element, mobile ecommerce application content block element, mobile ecommerce product category banners and icons elements, mobile ecommerce product promotional box, mobile ecommerce product discount label or ribbon display element, mobile ecommerce product navigations button elements etc., are provided in the proposed invention. This invention also lacks to validate various other conditions as described in the proposed invention and checks only for the time and user's location conditions.

The invention ‘System and method for dynamic provisioning of mobile application content’ U.S. Pat. No. 9,712,639 [Jul. 18, 2017], is an invention that claims to the systems, methods for a single mobile application to receive dynamically customized content based on the criteria and/or preferences that influence the dynamically customized content may be defined by a user and/or may be automatically detected by a user's mobile application or device. This invention is dealing with the user location, user culture or region to define the dynamic content for the mobile application as language texts, image, culture or region-specific content from a defined list. This invention is different from the proposed method for changing and displaying mobile commerce elements in a native mobile commerce application based on the criteria engine that validates different rules like, user's location, user's mobile device model, user's mobile OS type and its version, user's language, user's product browsing behavior, user's notifications and recommendations profile settings, user's demographic data and not limited to this list.

The invention ‘Mobile device and method of executing application based on particular zone’ U.S. Pat. No. 9,986,085 [May 29, 2018], is an invention that claims to a device and method that executes an application in a predetermined area. The mobile terminal that executes the application in the predetermined area based on the location finder configured executing an application that is predetermined for the area corresponding to the obtained location information and installs the application and the OS in the memory. This invention is defined for installing and executing the application in the mobile device for the location specified whereas the proposed system enables the merchant to load and display the screen options and mobile commerce elements such as mobile ecommerce shopping cart element, mobile ecommerce product price display element, mobile ecommerce advertisement banners display element, mobile ecommerce promotional banners display element, mobile ecommerce product navigation element, mobile ecommerce URI element, mobile ecommerce application content block element, mobile ecommerce product category banners and icons elements, mobile ecommerce product promotional box, mobile ecommerce product discount label or ribbon display element, mobile ecommerce product navigations button elements etc., depending on the criteria engine validation rules like user's location, user's mobile device model, user's mobile OS type and its version, user's language, user's product browsing behavior, user's notifications and recommendations profile settings, user's demographic data etc.,

The invention ‘End-to-end mobile commerce modules’ U.S. Pat. No. 6,697,839 [Feb. 24, 2004], is an invention that claims to a provide the capability of information input to the mobile application, such as to the online forms, wallet form field information used with mobile applications. This invention utilizes a server-side approach, in that when a form is encountered, fields of the form are filled with stored information based on automatically generated mapping information. This invention is providing the support for the displaying of above said list of mobile commerce elements and changing their position dynamically without publishing the app and displaying based on the defined conditions set by the merchant users.

The invention ‘Automated cross-platform native mobile application generation with cloud driven user interface and workflow synthesis’ U.S. Pat. No. 9,430,207 [Aug. 30, 2016], is an invention that claims to a cloud-based web platform for creating and managing native smartphone and tablet software applications for devices of different platforms based on a unified mobile specification is disclosed. The platform comprises a mobile application builder for creating, maintaining and editing a mobile application specification and a mobile application engine for automatic compiling native mobile applications based on the mobile application specification. The platform further comprises method to deploying the native mobile applications to selected client devices. This invention requires the user to define the specification for the application workflow, then compiles the code for the device specific platform & hardware and then distribute & deploy in the client device, where in the proposed invention method describes the displaying of above said list of mobile commerce elements, changing their position dynamically without publishing the app and displaying based on the defined conditions set by the merchant users instantly and without compiling, publishing to the different native mobile application online distribution stores.

The invention ‘Method and apparatus for converting a website into a native mobile application’ U.S. Pat. No. 9,448,776 [Sep. 20, 2016], is an invention that claims to automatically convert a website into a native app for execution by a mobile computing device such as an Android device or an iOS device. This invention primarily scans or process the website, checks its specification and converts the website into a native mobile application with the similar website content and links generated from the web site specification whereas the proposed invention deals with the mobile commerce native application that displays the above said mobile commerce elements based on the rules and the environment conditions defined by a merchant such as user's location, user's mobile device model, user's mobile OS type and its version, user's language, user's product browsing behavior, user's notifications and recommendations profile settings, user's demographic data etc.,

The invention ‘Methods and systems for inserting content in a mobile application’ U.S. Pat. No. 9,940,304 [Apr. 10, 2018], is an invention that claims for the systems and methods for automatically providing third-party content for display in a mobile application based on an interaction with the mobile application based on the one or more processor, application context or category, and mobile application memory and the content insertion policy. This invention primarily deals with the use case of advertisement programs wherein the third-party contents are inserted within the mobile application in between based on the user's viewing application content or its category. The proposed application is different as it is meant for method for displaying the mobile commerce elements and method for changing the screen options & positions of the mobile commerce elements within a native application based on the merchant conditions defined and without publishing to the application distribution stores.

The invention ‘Location and contextual-based mobile application promotion and delivery’ U.S. Pat. No. 9,936,333 [Apr. 3, 2018], is an invention that claims to the methods for selecting one or more mobile device applications using context data describing the current environment of a mobile device and application metadata describing environment conditions where applications are more likely to be relevant. The method comprises associating metadata with mobile device applications automatically receiving context data representing a current geographical location from a mobile phone, searching the metadata to determine which applications are likely of interest based on the current geographical location, and transmitting notification data to the mobile phone indicating the determined applications. This invention discovers the new mobile device applications based on the current context of a mobile device and its environment whereas, the proposed invention displays the native mobile commerce elements within a native ecommerce application based on the conditions defined by the merchant and other conditions that match with user's mobile device, profile etc.,

The invention ‘Interactive notifications for mobile commerce applications’ U.S. Pat. No. 9,922,357 [Mar. 20, 2018], is an invention that claims to a method for interactive notifications, from merchants or others soliciting a user response, are provided to the users' mobile devices for facilitating user engagement and receiving customer feedback. The interactive notifications such as buttons for purchasing the product or indicating that the user is not interested, enabling a user to immediately respond to the notification and these analytical data are collected for tailoring future notifications. This invention collects the user information and consents via buttons and feedback texts. This invention lacks the mobile commerce elements for the native mobile application that are said in the proposed invention such as mobile ecommerce shopping cart element, mobile ecommerce product price display element, mobile ecommerce advertisement banners display element, mobile ecommerce promotional banners display element, mobile ecommerce product navigation element, mobile ecommerce URI element, mobile ecommerce application content block element, mobile ecommerce product category banners and icons elements, mobile ecommerce product promotional box, mobile ecommerce product discount label or ribbon display element, mobile ecommerce product navigations button elements etc.,

The invention ‘System and method for mobile commerce’ U.S. Pat. No. 9,912,423 [Mar. 6, 2018], is an invention that claims to a system for and method of implementing mobile commerce in a satellite radio broadcasting system using an unique program identifier associated with each program segment of a broadcast. When a listener hears a radio program segment of interest, the listener causes the associated program identifier to be captured and thereafter transferred to a central location to initiate an e-commerce transaction involving the listener and/or other parties including merchandisers and advertisers. This invention uses of radio program via mobile device or similar device without internet enabled native mobile application but the proposed invention displays the mobile commerce elements on the native mobile application. The proposed invention enables the users to interact directly with the merchants via native mobile application using the dynamic ecommerce elements displayed on the user's native mobile application.

The invention ‘System and method for location and time specific mobile commerce’ U.S. Pat. No. 9,830,625 [Nov. 28, 2017], is an invention that claims to a method for location and time specific merchandising display and commerce related to that after verifying device location and event date and time. This invention lacks the display of other mobile commerce elements as said above depending on the criteria defined by the merchant and other user device, user profile or demographic etc.,

The invention ‘Executing a populated code template to generate a browser-executable software program to present a web page as a mobile application’ U.S. Pat. No. 9,501,458 [Nov. 22, 2016], is an invention that claims to a browser-executable software program for presenting a web page that provides the “look and feel” and functionality of a mobile application can be automatically generated from a mobile application specification. This invention lacks the feature of native ecommerce mobile application and lacks the display of the mobile commerce elements as said above. This method produces the HTML page/applications that are executed within a browser and look like a mobile application.

The invention ‘Methods and apparatuses for dynamically generating mobile application layouts using client independent configuration’ U.S. Pat. No. 9,268,562 [Feb. 23, 2016], is an invention that claims to the methods to optimizing the creation and loading of application interface layouts via a platform for generating configuration files for mobile applications. The apparatus uses mobile workbench, mobile configuration file and mobile client device. The mobile workbench receives drag-and-drop layout definition input from a developer and creates a mobile configuration file based on the developer's input. The mobile workbench can then dynamically update the mobile configuration file as the developer updates the application layout. The developer and/or the mobile workbench can send the updated application layout to mobile applications running on client devices and need not re-download the mobile application to render the updated application layout. This invention lacks the interface and provisions for the merchant or the end user to define the application layout themselves. This invention requires the developer to design the layout and generate configuration file which will be send to mobile devices for rendering the application screens. The proposed invention enables the merchant users and administrator or ecommerce application to design, change and specify the screen options and elements to be displayed on the customer's mobile application without intermediary configuration file. The changes done by Merchant user are stored directly in the web server and to the customer device's ecommerce mobile application. This invention displays the ecommerce specific options on application screen and components specific for the merchant user or application defined by the developer whereas the proposed invention displays the ecommerce application screens, designated layout, ecommerce app elements in the customer's device application depending on the rules and conditions defined by the merchants using customer's profile, environment and other demographic information. The components and elements described in this invention are limited and are different to our proposed invention, ‘Method for displaying and changing mobile commerce elements within native application instantly without code build’. This invention is having the component elements such as, Barcode scanner element, save picture element, Notification element, Search as you type element, Search refinement element, Product ratings element, Audio search element and Geo-fences element. The ecommerce elements of the proposed invention are mobile ecommerce shopping cart element, mobile ecommerce product price display element, mobile ecommerce advertisement banners display element, mobile ecommerce promotional banners display element, mobile ecommerce product navigation element, mobile ecommerce URI element, mobile ecommerce application content block element, mobile ecommerce product category banners and icons elements, mobile ecommerce product promotional box, mobile ecommerce product discount label or ribbon display element, mobile ecommerce product navigations button elements and this list is not limited.

The invention ‘Dynamically generating a mobile application’ U.S. Pat. No. 8,918,712 [Dec. 23, 2014], is an invention that claims to the method and apparatus for dynamically generating a mobile application using a server generated configuration file based on the launched application. The configuration file will be used in the mobile device for generation of a user interface that includes a first display area using browser functionality of the mobile device to display one or more web page elements formatted by the server to appear as native to the mobile device. The user interface further includes a second display area having one or more interface elements that are native to an operating system of the mobile device. This invention is displaying the content on a mobile screen using both, browser displayed and using native navigational elements like buttons. This invention lacks the display of mobile commerce elements within a pure native ecommerce mobile application whereas the proposed invention provides this function.

The invention ‘Mobile application builder’ U.S. Pat. No. 7,184,801 [Feb. 27, 2007], is an invention that claims to define a method and system for user to define and edit the workflow of the applications for a mobile device, screens associated with the applications. This invention lacks the specific components and elements of a native mobile commerce application as said above and it associates the variables, global variables and functions using these variables and the data source for the workflow of the application. Whereas, the proposed invention enables merchant user to define, specify, store, display and change the positions of the mobile commerce elements within the native mobile commerce application. This invention generates as new application whereas the proposed application updates on existing native mobile commerce application resides in the user device without publishing the application through mobile application online distribution stores.

### OBJECTS OF THE INVENTION

One or more of the problems of the conventional prior art may be overcome by various embodiments of the present invention, including this method doesn't require resubmitting and relaunch of the app to the respective mobile app stores.

The invention method of defining the rules and ecommerce elements code and screen options at once from the web interface by the merchant overcome the time, effort and other overhead involved in the prior art or process of designing, developing and publishing mobile commerce elements within a native application. The merchant doesn't require to invest time, money and significant effort for developing location specific ecommerce application screen options and elements for every changes required within the application using this invention methods.

One embodiment user profile and demographic rule-based displaying of the ecommerce screen options and elements enables the customers to view their personalized and guided shopping based on their location, occasions, age, gender, interests, and size profile. This also helps merchants to increase the customer engagement and proportionally increase in sales conversion of their products.

### SUMMARY OF THE INVENTION

The systems and methods of displaying and changing mobile commerce elements within native application instantly without code build comprises of different system components and methods as listed here.

The component of mobile commerce application screen options and elements specifications can be from either a separate native ecommerce mobile application app screen builder. The specifications for the display of the mobile commerce application screen options and ecommerce elements can also set through the displaying settings code file like YAML or XML formats or other similar computer code formats.

The one embodiment includes the method for configuring display rules, conditions for rendering and positioning of ecommerce control elements into the native ecommerce mobile application by the merchants. The merchants can do these rule settings through a web interface setting.

The merchant can then use different data sources for linking the data and content required for the display of the ecommerce elements into the native mobile application through this interface. And, these data sources can be one or different data sources like relational database storage, flat file database storage, internal cache storage, computer code format, extensible markup language format, JavaScript Object Notation (JSON) format and mnemonics language like text format. These ecommerce element codes and rule settings are stored in the web server and will be synchronized with the user's mobile device storage via eCommerce API.

The embodiment of Application Programming Interface transmits data and information between web server and the customer's mobile device to synchronize the latest version of the screen options code, rules code and ecommerce element code defined by the merchant.

This embodiment uses the timestamp and other sequential version numbering to match between the server and the user's mobile device. The timestamp and/or the version number at the server will be latest or highest one than the other client device application versions for these codes.

If there are any lowest version number of codes available in any of the client device native ecommerce mobile application than this web server application code then the client application will request for updated code for screen option settings, ecommerce element settings and rule settings. The web server will then synchronize the rule data set to the client device application.

For the purpose of displaying and changing the ecommerce application elements the client device must have a valid native ecommerce application installed, running and synchronized with the web server for both data and application profiles.

The user's mobile device must have a system for capturing user profile information, device specific environment details and user behavior in product browsing history, size profile settings, interest settings. The native ecommerce mobile application may have the user profile data collection system. The user can also synchronize their social profile data using which the user's interest can be found to advice the related products depending on his browsing experience.

This profile and demographic data capture engine will collect this information about the user and sends the same to the criteria validation engine to check against the merchant defined rules. The demographic and environment data that are collected and checked against the rules are age, gender, interests, personal size profile, user's recent product browsing behavior, user's browsing time behavior, user device OS platform, user device OS version, user device hardware version etc., The criteria validation engine may check one or more combination of rules and give the results to the display and rendering engine in the native ecommerce mobile application.

The eCommerce Application Programming Interface (API) will transmit the ecommerce elements, link URIs for the elements, product information and other property information to the native mobile application's internal cache storage respective to the rules, element data and screen option data latest version.

If the validation engine passes the rule and elements to render to the render and display engine, the corresponding ecommerce element will be displayed using the properties, settings, styles and other parameters passed from the web server to the internal storage of the mobile commerce application. The page will be built instantly for each of these elements through this process flow and renders the ecommerce elements.

The native ecommerce mobile application will have defined code built in for the different ecommerce elements and depending on the element display rules and specification, the ecommerce elements will be rendered in their defined positions.

The embodiment includes the element display for mobile ecommerce product price display element.

The embodiment includes the element display for mobile ecommerce advertisement banners display element.

The embodiment includes the element display for mobile ecommerce promotional banners display element.

The embodiment also includes the element display for mobile ecommerce product navigation element and mobile ecommerce URI element.

The embodiment includes the element display for mobile ecommerce application content block element and mobile ecommerce product category banners and icons elements.

The embodiment includes the element display for mobile ecommerce shopping cart display element or quick shopping cart element.

The embodiment also includes the element display for mobile ecommerce product promotional box and mobile ecommerce product discount label or ribbon display element.

The other elements that can be rendered in a native mobile commerce application of this embodiment are checkout button element, product sliders element, tag cloud element, top selling products element, best products element, deal products elements, flash sale timer element, product statistics element, support call display element and the elements list in this embodiment is not limited to this list.

While this embodiment displays the ecommerce elements in a user device native mobile application based on these rules and validation, this displays across the Application Programming Interface (API) over internet and doesn't require code modification, code rebuild and application publishing in the online application distribution stores like Google's Play Store and Apple's iTunes Store.

### BRIEF DESCRIPTION OF THE DRAWINGS

FIG. 1 is the high-level system design diagram for the method of displaying and changing mobile commerce elements within native application instantly without code build. The system consists of five sections namely, Native ecommerce mobile application builder web interface or native ecommerce elements display specification, Native mobile commerce screen settings and display rules settings web interface, Mobile commerce application programming interface (API), Mobile device with ecommerce mobile application, Customer profile data capture and Criteria validation engine.

FIG. 2 is the system diagram of the Mobile commerce elements render engine that describes the flow, system components for the method for displaying and changing mobile commerce elements within native application instantly without code build. The system diagram illustrates the different ecommerce elements that are claimed to be rendered using this invention method and system like mobile ecommerce shopping cart element, mobile ecommerce product price display element, mobile ecommerce advertisement banners display element, mobile ecommerce promotional banners display element, mobile ecommerce product navigation element, mobile ecommerce URI element, mobile ecommerce application content block element, mobile ecommerce product category banners and icons elements, mobile ecommerce product promotional box, mobile ecommerce product discount label or ribbon display element, mobile ecommerce product navigations button elements, mobile commerce product sliders element, mobile commerce top selling products element, mobile commerce best products elements, mobile commerce deal products element, mobile commerce flash sale timer element, mobile commerce support call element, mobile commerce product statistics element etc.,

FIG. 3 is the functional flow of the displaying and changing mobile commerce elements within native application instantly without code build.

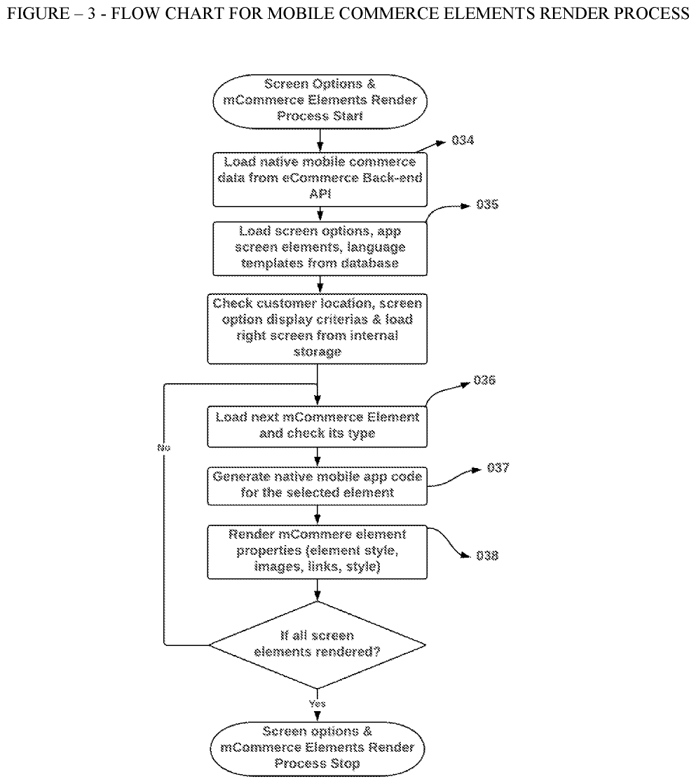

### DETAILED DESCRIPTION OF THE INVENTION DRAWINGS

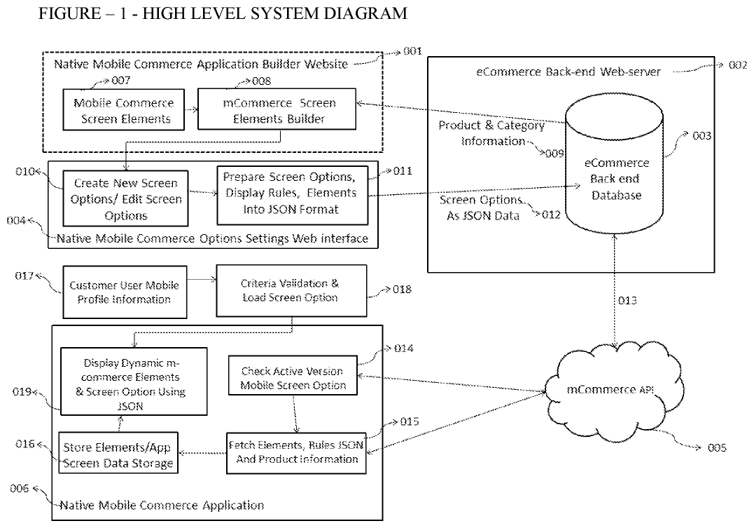

In one of the embodiments, FIG. 1 of high-level system design, the different sub-sections of the system are: native mobile commerce application builder website (001), ecommerce web back-end server (002), ecommerce back-end database for storage (003), native mobile commerce screen option and rules settings web interface (004), ecommerce Application Programming Interface (005), native mobile commerce application (006).

The merchant user will design and define the mobile commerce screen elements (007) through the native mobile commerce application builder website. The merchant uses the interfaces for the mobile commerce screen & elements builder, configuration web interface (008) and defines the properties of the each elements. This interface uses the product and product category information (009) from the ecommerce back-end web server so that it will embed into the ecommerce element properties.

In the above said embodiment, the sub-section native mobile commerce screen option settings web interface used by the merchants to define the screen options and positions to be rendered in the user's mobile application using the screen options editor (010).

The merchant user can create new screen options and assign a number or edit from existing screen options or copy from existing screen options for creating new screen options. The merchant will also define the display rules, user profile/demographic rules, elements display order positions and other element association properties in the screen options editor interface (011). The merchant can also define these rules and property settings through the markup languages like XML or YAML.

In this embodiment sub-section, the rules, ecommerce elements and its properties are transmitted to the web server as JSON format (012) via RESTful API web services. The eCommerce API will consume (013) these rules and ecommerce elements data from the back end web-server.

In an exemplary embodiment there is a sub-section, native mobile commerce application in which the version checker component (014) will check the active version of the rules defined in the server against the display rules data version stored in the mobile application of the user device. If the version of the data is higher than that of the user mobile device, then the latest version of display rules data, ecommerce elements data, and screen option data from server (015) to local data storage of the user's mobile device (016).

In another sub-section of the embodiment, the customer profile information, user device environment details will be fetched for validation (017).

The gathered user profile information, demographic information and user mobile device environment information will be send to criteria validation engine (018) located inside the native ecommerce mobile application. This engine will verify the data and decides whether the ecommerce elements should be displayed in the user's native mobile application screen or not based on the rules defined by the merchant in screen options editor and specification (011)

The embodiment, native ecommerce mobile application ecommerce elements rendering engine (019) will display the elements data taken from the local storage in the JSON data format and according the rules validation engine in the native ecommerce mobile application as the native mobile application elements for all platform with its specific native code without any code build and application publish process in the Google Play Store and Apple iTunes Store. For this the native ecommerce application of the merchant for each platform must be submitted and deployed successfully in the online distribution application store (Google Play Store and Apple iTunes Store) at least once.

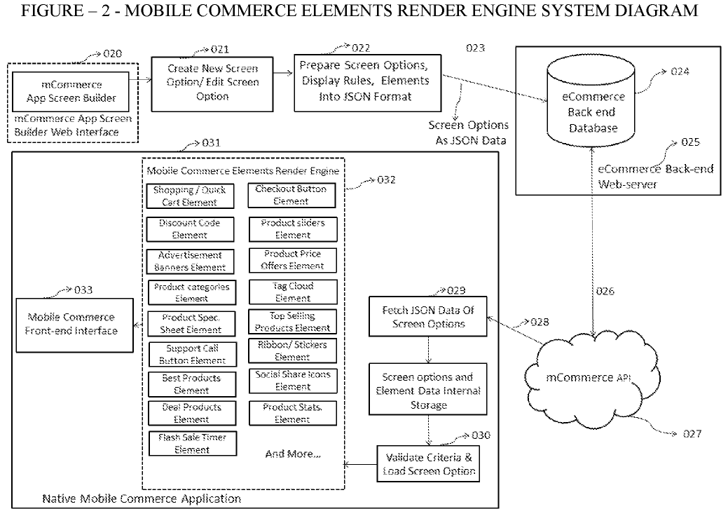

In the FIG. 2, the components of the systems (020) through (031) and their functional flow were described in the above points [0051] through [0056] including all the ideal embodiments.

In an important embodiment in the FIG. 2, the mobile commerce elements render engine (032) that will fetch the computer codes for the respective ecommerce elements for the specific mobile device OS platform (iOS or Android or other platform) and render the elements in the mobile commerce native application front end interface (033).

In this embodiment, mobile commerce elements render engine (032), the different elements that are rendered are, Shopping cart/quick cart element, Checkout button element, Discount code element, Product Slider element, Advertisement banner element, Product categories element, Product price offers display element, Product specification sheet icon element, Tag cloud element, Support call button element, Top selling element, Best products element, Ribbons/stickers element, Deal products element, Flash sale timer element, Product statistics element and more elements.

Although only a few exemplary embodiments of this invention have been described in detail above, those skilled in the art will readily appreciate that many modifications are possible in the exemplary embodiments. Accordingly, all such modifications are intended to be included in the scope of this invention as defined in the following claims. In the claims, means-plus-function clauses are intended to cover the structures described herein as performing the recited function and not only structural equivalents, but also equivalent structures.

This invention is further described through the above said working mode of the said methods and processes of the displaying and changing mobile commerce elements within native application instantly without code build, which is only illustrative in the nature and should not be construed to limit the scope of invention.

1. The methods and systems of displaying and changing mobile commerce elements within native mobile application instantly without code build that comprises, the mobile specifications from a native ecommerce mobile application screen builder and/or other similar mobile elements display settings; displaying rule and functional specification for rendering and positioning the ecommerce control elements into the native ecommerce mobile application; plurality of the data storage, methods and formats for storing the said mobile commerce elements in the web server; the application programming interfaces for transmitting between user device, native ecommerce mobile application and web server for the purpose of displaying and changing without application store submission and updating code in user devices; user mobile devices with native ecommerce mobile application synchronized with the data sources and web servers; user profile, demographic and environment data capture system in user mobile device; the internal cache storage component & criteria validation engine within native ecommerce mobile application in user mobile device for the purpose of validating merchant defined rules against user profile, demographic, environment data then to select, display ecommerce elements in the application; the ecommerce layout elements that includes, mobile ecommerce product price display element, mobile ecommerce advertisement banners display element, mobile ecommerce promotional banners display element, mobile ecommerce product navigation element, mobile ecommerce URI element, mobile ecommerce application content block element, mobile ecommerce product category banners and icons elements, mobile ecommerce shopping cart display element, mobile ecommerce product promotional box, mobile ecommerce product discount label or ribbon display element, mobile ecommerce product navigations button elements and this list is not limited to. The merchant users define the elements from the builder tool, define the elements to display, its order position in the screen, elements style and color settings, product and category associated to the element including banners, sliders, icons, rules for displaying to specific user demographic and user device environment profiles that includes age, gender, interests, recent product browsing behavior, browsing time behavior, user device OS platform and version, user device hardware version etc., The method also comprises sending these layout information, ecommerce element information that are defined, rules settings information as an application programmable interface from web server to user's mobile device. The method in user mobile application checks for the updates to these layouts, elements, rules information version from web server to client devices and pulls from web server for latest version. The system in user device will capture user demographics, profile information device environment conditions etc, and send to validation engine within the native ecommerce mobile application. The method validates these captured information and conditions for match and loads the native ecommerce elements and styles that are defined according to the merchant definition to the user and displayed as native ecommerce application code without publishing to the online application distribution store and displayed instantly into the client devices.

2. The method of the claim 1, wherein the mobile specifications can be for different platforms including iOS and Android mobile operating system platforms and these specifications can be from another system of native ecommerce mobile application screen builder or computer program settings code for display purpose.

3. The method of the claim 1, wherein the displaying rule and functional specification can be one or more combinations from display order position of the ecommerce element on the mobile application screen, color style/font style/font size of the texts being displayed in ecommerce element, link to the products associated for the ecommerce element, link to the categories associated for the ecommerce element, product count associated for the ecommerce element to be displayed, location of the user device, age of the user, gender of the user, hardware of the user device, operating system of the user device, operating system version of the user device, product category browsing behavior of the user, user browsing time pattern of the application.

4. The method of the claim 1, wherein the data storage, methods and formats for storing the said mobile commerce elements can be any one or more combination of the storage, format and methods from relational database storage, flat file database storage, internal cache storage, computer code format, extensible markup language format, JavaScript Object Notation (JSON) format, mnemonics language such as text format.

5. The method of the claim 1, wherein the application programming interfaces for transmitting between user device, native ecommerce mobile application and web server can be any one from the methods Representational State Transfer (REST) format, JavaScript Object Notation (JSON) format or Simple Object Access Protocol (SOAP) format.

6. The method of the claim 1, wherein the user profile, demographic and environment data capture system fetch data of the user from any one or combination of systems from native mobile commerce application profile, device's GPS (Global Positioning System) information, customer device camera, customer device operating system information, customer ecommerce application browsing history logs.

7. The method of the claim 1, wherein the criteria validation engine within native ecommerce mobile application check for match with user profile, demographic and device environment data with merchant user defined rules for exact match or nearest match settings.

8. The method of the claim 1, wherein the mobile ecommerce elements that can be displayed or changed in the native mobile application without code changes and instantly are any one or more than one combinations from mobile ecommerce product price display element, mobile ecommerce advertisement banners display element, mobile ecommerce promotional banners display element, mobile ecommerce product navigation element, mobile ecommerce URI element, mobile ecommerce application content block element, mobile ecommerce product category banners and icons elements, mobile ecommerce shopping cart display element, mobile ecommerce product promotional box, mobile ecommerce product discount label or ribbon display element, mobile ecommerce product navigations button elements, mobile ecommerce quick cart element, mobile ecommerce checkout button element, mobile ecommerce product slider element, mobile ecommerce support call/quick call element, mobile ecommerce best products element, mobile ecommerce top selling products element, mobile ecommerce deal products element, mobile ecommerce flash sale timer element, mobile ecommerce product statistics display element.

9. The method of the claim 1, wherein the data of layouts, elements and display rules specifications are maintained in a version numbering at the web server when the merchant user stores and are synchronized with user device's stored specification to the latest version through device update application programmable interface function.

10. The method of the claim 1, wherein the method for displaying the ecommerce elements within the user device's ecommerce mobile application instantly and without code build process for any native mobile platform and no need for submitting the mobile application code to the online mobile application distribution stores like Google's Play Store and/or Apple's iTunes Store.
